(19) United States
(12) Patent Application Publication
(10) Pub. No.: US 2021/0304636 A1
(43) Pub. Date: Sep. 30, 2021

(54) APPARATUS AND METHOD FOR PARTICIPANT ENGAGEMENT SYSTEM

(71) Applicant: Samantha Desmond, Everett, WA (US)

(72) Inventor: Samantha Desmond, Everett, WA (US)

(21) Appl. No.: 17/213,612

(22) Filed: Mar. 26, 2021

Related U.S. Application Data
(60) Provisional application No. 63/002,152, filed on Mar. 30, 2020.

(51) Int. Cl. G09B 19/00; G09B 9/00

(52) U.S. Cl. CPC G09B 19/00; G09B 9/00

(57) ABSTRACT

A treatment curricula presentation system and method is provided. One embodiment presents a story line arc to a participant, wherein the story line arc is one of the plurality of story line arcs of a story line, and wherein the each story line arc has an associated first core learning element that is internalized by the participant during the course of consuming the story line arc; monitors the participant during and after presentation of the story line arc to determine whether the participant has consumed the story line arc; and presents a next story line arc to the participant, after presentation of the first story line arc.

### PRIORITY CLAIM

This application claims priority to copending U.S. Provisional Application, Ser. No. 63/002,152, filed on Mar. 30, 2020, entitled Apparatus and Method For Participant engagement System, which is hereby incorporated by reference for all purposes.

### BACKGROUND OF THE INVENTION

In the arts of patient treatment and recovery practices, a participant patient may engage in a planned and controlled recovery program. However, a non-participant patient experience a lack of engagement in a progressive treatment curricula and/or program.

The non-participant may manifest a lack of personal investment of energy, effort, and progress. The non-participant may exhibit a drop-off in engagement levels over time. The non-participant may exhibit hostility and/or aggression to the treatment curricula and/or program. The non-participant patient may exhibit a lack of understanding surrounding base treatment curricula and/or program. Some non-participants may hyper focus on undesired elements surrounding treatment curricula and/or program. The non-participant may exhibit a brief distraction from personal events and/or a lack of hope regarding their progression through the treatment curricula and/or program. In some situations, the non-participant may zone out throughout the treatment curricula and/or program, and/or the patient may exhibit defensiveness surrounding personal progression or lack thereof. If the non-participant's mental state dissolves, the participant may exhibit behavior potentially triggering confrontations. The non-participant may experience feelings of isolation/loneliness, a lack of common ground, boredom and/or a lack of fun in a core treatment curricula and/or program.

In a pathways specific version of a treatment curricula and/or program, the participant and/or the non-participant may exhibit communication and socialization difficulties, lack of understanding regarding the addiction process, lack of self-awareness, aggression and/or hostility, denial of problem(s), refusal of accountability, lack of integrity, distrust of others, and/or difficulty of experiencing fun outside of the addiction.

Accordingly, there is a need in the arts for improved methods and systems of developing and managing treatment curricula and/or programs for participant and non-participant patients.

### SUMMARY OF THE INVENTION

Embodiments of a participant engagement system (PES) are treatment curricula presentation system and method. One embodiment presents a story line arc to a participant, wherein the story line arc is one of the plurality of story line arcs of a story line, and wherein the each story line arc has an associated first core learning element that is internalized by the participant during the course of consuming the story line arc; monitors the participant during and after presentation of the story line arc to determine whether the participant has consumed the story line arc; and presents a next story line arc to the participant, after presentation of the first story line arc.

### BRIEF DESCRIPTION OF THE DRAWINGS

The components in the drawings are not necessarily to scale relative to each other. Like reference numerals designate corresponding parts throughout the several views.

FIG. 1 is an example block diagram of an example computing system that may be used to practice embodiments of a participant engagement system (PES).

FIG. 2 is a structural diagram that graphically depicts a conceptual story line used by an example PES during treatment of a plurality of participants.

FIG. 3 is a flow chart showing operations of an embodiment of the PES.

FIG. 4 is a PES program and/or setting interaction chart.

### DETAILED DESCRIPTION

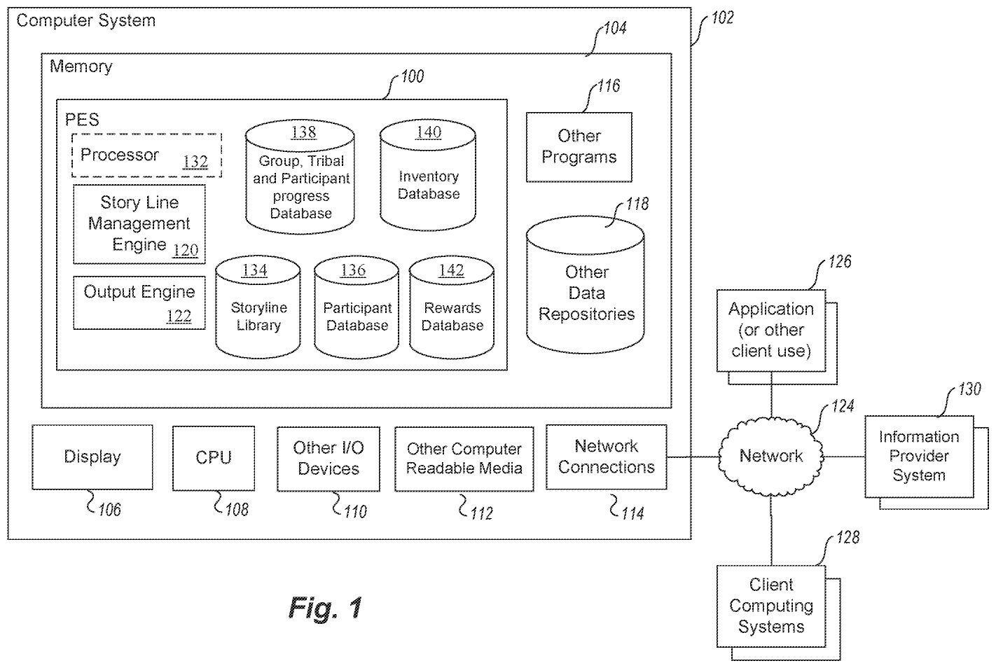

FIG. 1 is an example block diagram of an example computing system that may be used to practice embodiments of a participant engagement system (PES) 100 described herein. Embodiments of the PES 100 provide a system and method for improving engagement by a participant and a non-participant, interchangeably referred to herein as patients, in a treatment curricula and/or program.

The disclosed PES 100 will become better understood through review of the following detailed description in conjunction with the figures. The detailed description and figures provide merely examples of the various inventions described herein. Those skilled in the art will understand that the disclosed examples may be varied, modified, and altered without departing from the scope of the inventions described herein. Many variations are contemplated for different applications and design considerations; however, for the sake of brevity, each and every contemplated variation is not individually described in the following detailed description.

Throughout the following detailed description, examples of various PESs 100 are provided. Related features in the examples may be identical, similar, or dissimilar in different examples. For the sake of brevity, related features will not be redundantly explained in each example. Instead, the use of related feature names will cue the reader that the feature with a related feature name may be similar to the related feature in an example explained previously. Features specific to a given example will be described in that particular example. The reader should understand that a given feature need not be the same or similar to the specific portrayal of a related feature in any given figure or example.

The following definitions apply herein, unless otherwise indicated.

“Substantially” means to be more-or-less conforming to the particular dimension, range, shape, concept, or other aspect modified by the term, such that a feature or component need not conform exactly. For example, a “substantially cylindrical” object means that the object resembles a cylinder, but may have one or more deviations from a true cylinder.

“Comprising,” “including,” and “having” (and conjugations thereof) are used interchangeably to mean including but not necessarily limited to, and are open-ended terms not intended to exclude additional, elements or method steps not expressly recited.

Terms such as “first”, “second”, and “third” are used to distinguish or identify various members of a group, or the like, and are not intended to denote a serial, chronological, or numerical limitation.

“Coupled” means connected, either permanently or releasably, whether directly or indirectly through intervening components.

FIG. 1 is an example block diagram of an example computing system that may be used to practice embodiments of a PES 100 described herein. Note that one or more general purpose virtual or physical computing systems suitably instructed, or a special purpose computing system may be used, to implement an embodiment of the PES 100. Further, the PES 100 embodiments may be implemented in software, hardware, firmware, or in some combination to achieve the capabilities described herein.

Note that one or more general purpose or special purpose computing systems and/or devices may be used to implement the described techniques practiced by embodiments of the PES 100. However, just because it is possible to implement the PES 100 on a general purpose computing system does not mean that the techniques themselves or the operations required to implement the techniques are conventional or well known.

The computing system 102 (interchangeably referred to herein as a computer system 102) may comprise one or more server and/or client computing systems and may span distributed locations. In addition, each block shown may represent one or more such blocks as appropriate to a specific embodiment or may be combined with other blocks. Moreover, the various blocks of the PES 100 may physically reside on one or more machines, which use standard (e.g., TCP/IP) or proprietary interprocess communication mechanisms to communicate with each other.

In the embodiment shown, computer system 102 comprises a computer memory (“memory”) 104, a display 106, one or more Central Processing Units (“CPU”) 108, Input/Output devices 110 (e.g., keyboard, mouse, CRT or LCD display, etc.), other computer-readable media 112, and one or more network connections 114. The PES 100 is shown residing in memory 104. In other embodiments, some portion of the contents, some of, or all of the components of the PES 100 may be stored on and/or transmitted over the other computer-readable media 112. The components of the PES 100 preferably execute on one or more CPUs 108 (or processor 132) and manage the operation of the PES 100, as described herein. Such CPUs 108 and processor 132 (interchangeably referred to herein as a processing system) are interchangeably referred to herein as a processing system. Other code or programs 116 and potentially other data repositories, such as data repository 118, also reside in the memory 104, and preferably execute on one or more CPUs 108. Of note, one or more of the components in FIG. 1 may not be present in any specific implementation. For example, some embodiments embedded in other software may not provide means for user input or display.

In an example embodiment, the PES 100 includes one or more story line management engines 120, and optionally one or more output engines 122. In at least some embodiments, one or more of the PES 100 components may be provided external to the computer system 102 and is available, potentially, over one or more networks 124. Other and/or different modules may be implemented. In addition, one or more of the PES 100 components may interact via a network 124 (using network connections 114) with application or client users 126 that provide various input information or data, one or more client computing systems 128, and/or one or more third-party information provider systems 130, such as patient information systems (via network connections 114 communicatively coupled to network 124). Also, of note, the data repository 118 may be provided external to the computer system 102 as well, for example in a world wide web (WWW) knowledge base that is accessible over one or more networks 124.

In an example embodiment, components/modules of the PES 100 are implemented using standard programming techniques and is implemented by the processor 132 (and/or the CPU 108). For example, the PES 100 may be implemented as a “native” executable running on the CPU 108, along with one or more static or dynamic libraries. In other embodiments, PES 100 may be implemented as instructions processed by a virtual machine. In general, a range of programming languages known in the art may be employed for implementing such example embodiments, including representative implementations of various programming language paradigms, including but not limited to, object-oriented (e.g., Java, C++, C#, Visual Basic.NET, Smalltalk, and the like), functional (e.g., ML, Lisp, Scheme, and the like), procedural (e.g., C, Pascal, Ada, Modula, and the like), scripting (e.g., Perl, Ruby, Python, JavaScript, VBScript, and the like), and declarative (e.g., SQL, Prolog, and the like).

The embodiments described herein may also use well-known or proprietary, synchronous or asynchronous client-server computing techniques. Also, the various components may be implemented using more monolithic programming techniques, for example, as an executable running on a single CPU computer system, or alternatively decomposed using a variety of structuring techniques known in the art, including but not limited to, multiprogramming, multithreading, client-server, or peer-to-peer, running on one or more computer systems each having one or more CPUs. Some embodiments may execute concurrently and asynchronously and communicate using message passing techniques. Equivalent synchronous embodiments are also supported.

In addition, programming interfaces to the data stored as part of the PES 100 (e.g., in the data repositories 118) can be available by standard mechanisms such as through C, C++, C#, and Java APIs; libraries for accessing files, databases, or other data repositories; through scripting languages such as XML; or through Web servers, FTP servers, or other types of servers providing access to stored data. The various components of the PES 100 may be implemented as one or more database systems, file systems, or any other technique for storing such information, or any combination of the above, including implementations using distributed computing techniques.

Also, the example PES 100 may be implemented in a distributed environment comprising multiple, even heterogeneous, computer systems and networks. Different configurations and locations of programs and data are contemplated for use with techniques of described herein. In addition, the [server and/or client] may be physical or virtual computing systems and may reside on the same physical system. Also, one or more of the modules may themselves be distributed, pooled or otherwise grouped, such as for load balancing, reliability or security reasons. A variety of distributed computing techniques are appropriate for implementing the components of the illustrated embodiments in a distributed manner including but not limited to TCP/IP sockets, RPC, RMI, HTTP, Web Services (XML-RPC, JAX-RPC, SOAP, etc.) and the like. Other variations are possible. Also, other functionality could be provided by each component/module, or existing functionality could be distributed amongst the components/modules in different ways, yet still achieve the functions of the PES 100.

Furthermore, in some embodiments, some or all of the components of the PES 100 may be implemented or provided in other manners, such as at least partially in firmware and/or hardware, including, but not limited to one or more application-specific integrated circuits (ASICs), standard integrated circuits, controllers executing appropriate instructions, and including microcontrollers and/or embedded controllers, field-programmable gate arrays (FPGAs), complex programmable logic devices (CPLDs), and the like. Some or all of the system components and/or data structures may also be stored as contents (e.g., as executable or other machine-readable software instructions or structured data) on a computer-readable medium (e.g., a hard disk; memory; network; other computer-readable medium; or other portable media article to be read by an appropriate drive or via an appropriate connection, such as a DVD or flash memory device) to enable the computer-readable medium to execute or otherwise use or provide the contents to perform at least some of the described techniques. Some or all of the components and/or data structures may be stored on tangible, non-transitory storage mediums. Some or all of the system components and data structures may also be stored as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames).

Such computer program products may also take other forms in other embodiments. For example, a processor 132 may be implemented in the memory 104. Information may be temporarily, and/or permanently, stored in a local memory 104. Accordingly, embodiments of this disclosure may be practiced with other computer system configurations. The output engine 122 manages generation of various output reports and/or staff instructions for management of the PES 100 in a format that is suitable for the particular I/O device 110 that is being used by staff to view the output reports. For example, such output reports and/or instructions may be presented on display 106.

An example embodiment of a PES 100 may include a storyline library 134, a participant database 136, a group, a tribal and participant progress database 138, an inventory database 140, and a rewards database 142. In some embodiments, the storyline library 134, the participant database 136, the group, tribal and participant progress database 138, the inventory database 140, and the rewards database 142 may be integrated together, and/or may be integrated with other data. In other embodiments, some or all of these memory and other data manipulation functions may be provided by using a remote server or other electronic devices suitably connected via the Internet or otherwise to a client device.

The storyline library 134 includes one or more storylines, described in greater detail hereinbelow. The stories in the storyline library 134 provide a framework for a particular treatment curriculum and/or program. As a particular PES 100 is progressing, story line drops can be accessed (and/or tracked) for delivery to participants, tribes and the group. As noted herein, such story line drops can be in an electronic format and stored in the storyline library 134. If story line drops are tangible physical assets, a relational database may be used to track such physical story line drops.

The participant database 136 includes various information about the participants of the treatment curriculum and/or program. Some portions of the information may be confidential. The participant information may be provided by the patients or other related parties, may be received from a client computing system 128 (such as, but not limited to, information provided in email correspondence received via network connections 114 communicatively coupled to network 124), and/or may be received from an information provider system 130 (such as, but not limited to, insurance companies, regulatory agencies, government agencies, or the like) received via network connections 114 communicatively coupled to network 124.

The participant progress database 138 includes information regarding the participant's, tribe's and/or group progress during the PES 100. Information may be input by staff. Reports can be generated and issued to staff so that they know what how participants, tribes and the group are progressing during the PES 100.

The inventory database 140 tracks physical assets used during an ongoing PES 100. For example, an example story line drop may be presented as a physical asset with text and pictures. As another non-limiting example, some rewards may be tangible items, such as apparel, consumables, food items, or the like. The information stored in the inventory database 140 may be used to manage and control the physical assets used in a PES. For example, before a physical asset story line drop is released or a tangible reward is released, information stored in the inventory database 140 can be used to verify availability of the physical asset. If particular physical assets become depleted, information stored in the inventory database 140 may be used to prompt staff to reorder, and/or the PES 100 may automatically reorder, physical assets. Reports can be generated and issued to staff so that they know what physical assets are available and what physical assets have been issued during the PES 100.

The rewards database 142 stores information pertaining to rewards that are available in and/or that are given to participants in the PES 100. If the rewards are a tangible asset, the inventory of available rewards can be tracked and/or managed by the PES 100. Reports can be generated and issued to staff so that they know what rewards are available and what rewards have been issued to participants.

In practice, the story line management engine 120, when executed by CPU 108, manages operation of one or more functions of the PES 100. The monitors performance of the individual participants, tribe, or group. The story line management engine 120 manages timing of and release of story line arcs of a story line, granting of awards and challenges, and/or other events described herein.

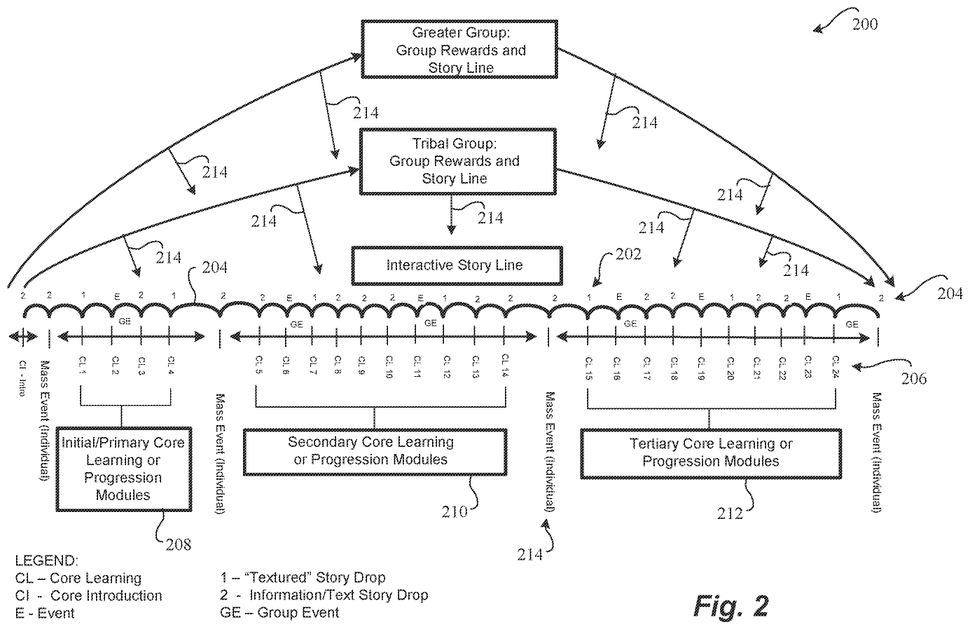

FIG. 2 is a structural diagram 200 that graphically depicts a conceptual story line 202 used by an example PES 100 during treatment of a plurality of participants. In a preferred embodiment, the story line 202 tells a theme-based story about some hypothetical protagonist, such as hero or the like, who is experiencing an adventure or the like. The protagonist is at the center of the story, makes the key decisions, and experiences the consequences of those decisions. The protagonist is the primary agent propelling the story forward, and is often the character who faces the most significant obstacles. If a story line 202 contains a subplot, or is a narrative made up of several stories, then each subplot may have its own protagonist.

The PES 100 provides an interlocking and overlapping system of story elements that move with each other. Elements of the PES 100 interact with the participants and with the program/curricula staff in order to weave the story together. Rewards are triggered by story drops, events, and/or milestones. Individual participants, tribal participant groups (small group of participants, such as roommates, selected individuals, or the like), or a group (all participants) may participate in the treatment curriculum and/or program. The progress of each individual participant, tribe and/or group can be monitored and tracked by the PES 100. Story drops and events are triggered by the amount of progress made by an individual participant, the tribe, or group as a whole, including a net zero progression or regression. Events will often have story drops and rewards attached to them based on how they were addressed and how the individual participant, tribe, or group did upon completing the event. In some embodiments, these processes are managed, in whole or in part, by the story line management engine 120 (FIG. 1).

The story line 202 comprises an ordered series of story line arcs 204. Each story line arc 204 pertains to an event of the story line 202. The story line 202 is preferably a thematic story that imparts information about some theme(s) that is believed to be of help to an individual participants, tribe, or group in a treatment curricula and/or program.

When the story line arcs 204 are presented to the participant (the patient participating in the PES 100) in the treatment curriculum and/or program in a serial fashion, the participant learns about the story line 202. Preferably, any particular story line arc 204 can be consumed by a participant in a relatively short period of time (duration). In the conceptual storyline 202 illustrated in FIG. 2, there are twenty four CL elements 206 (CL 1-CL 24).

Each story line arc 204 is constructed around a core learning (CL) element 206. Upon conclusion of the presentation of a particular story line arc 204 to the consuming participant, the participant has learned about (internalized) the associated CL element 206 in the consumed story line arc 204. That is, the story line arc has an associated CL element 206 that is internalized by the participant during the course of consuming the story line arc 204. Preferably, internalization of the CL element 206 will induce some positive change in the behavior, beliefs, and/or character of the participant. In some story lines 202, a CL introduction is provided that summarizes the intended CL elements 206 that the participant participating in the treatment curricula and/or program is to learn. In a preferred embodiment, the next story line arc is presented to the participant only if the monitoring indicates that the participant has internalized the current core learning element of the first story line arc.

For example, but not limited to, the protagonist described in the story line arc 204 may have an experience relating to the objective treatment curriculum and/or program of the PES 100. The individual participants, tribe, or group, while consuming the story line arc 204, experiences the protagonist's experience, and hopefully internalizes some aspect of the protagonist's experience (which is related to the CL element 206 of that story line arc 204). Accordingly, the individual participant, tribe, or group will then internalize the CL element 206.

Preferably, a story line 202 can be segmented into three general sections. The first section presents the initial/primary core learning or progression modules 208. The primary core learning imparts to the participants overall core objectives of the program. The next section presents secondary core learning or progression modules 210 to the participant(s). The secondary core learning imparts to the participants secondary core objectives of the program, which may be easier to internalize by the participant (after internalization of the primary core objectives) and/or may tangentially related to primary core objectives. The last section of the story line 202 presents tertiary core learning or progression modules 212 to the participant(s). The tertiary core learning imparts to the participants tertiary core objectives of the program, which may be easier to internalize by the participant (after internalization of the primary and secondary core objectives) and/or may tangentially related to primary core and/or secondary objectives.

Optionally, prior to the start of the storyline-based curriculum and/or program, a core introduction (CI) may be presented to the individual participant, tribe, or group. Here, an explanation of how the storyline-based curriculum and/or program is conducted, performance expectations, outcomes and/or rewards may be described so that each participant may understand their role as a participant, as a member of a tribe, and as a member of the group.

To facilitate the participant's learning about the CL elements 206, one or more individual story line arcs 204, or a limited number of story line arcs 204, are made available to the participant participating in the treatment curricula and/or program in a serial fashion. These events wherein the one or more story line arcs 204 are made available to the participant is referred to herein as a story drop.

Upon conclusion of a selected story line arc 204, the participant may be asked to participate in an event. An event may be any physical exercise, task, or the like in which the participant participates. An example event may be a hike by the participant, either alone or with other participants and/or staff members of the treatment facility. Other example events include, scavenger hunts, a tea party, a camp fire, a group relay, an initiation ceremony, a graduation ceremony or the like. Here, the participation in the event reinforces the intended CL element 206 of that associated story line arc(s) 204. Alternatively, or additionally, an event may be an electronic-based event, such a computer game. Alternatively, or additionally, an event may be a hybrid computer/real life game that is played in part on a computer, and that is played in part based on participation in a real life activity.

Alternatively, or additionally, upon conclusion of a selected story line arc 204 and/or an event, the participant may receive an award or reward. A reward is a tangible object or intangible benefit that is received by the participant. Rewards may include tokens (used in a token economy), medals, treasures, cash money, edibles (fruit, ice cream, candy, etc.), money stipends, privileges, or the like. Any suitable reward may be given to the individual participant, tribe, or group. Here, the received reward reinforces the intended CL element 206 of that associated story line arc(s) 204.

Story line arcs 204 may be presented using any suitable media format. Some story line arcs 204 may be made available in a story line drop in the form of physical text, such as a book, a scroll, a graphical novel (a comic book), or the like. Alternatively, or additionally, the text may be presentable using an electronic device, such as a personal computer, a personal digital reader, a smart phone, or other electronic device that has a display configure to present textual content. Some story line arcs 204 may be made available in the form of a computerized game or physical game. Some story line arcs 204 may be presented as a physical exercise wherein the participant acts out the actions of the story protagonist during that story line arc 204.

A milestone may be associated with a particular story line arc 204. Upon completion of that story line arc 204, the individual participant, tribe, or group has completed a milestone that corresponds to a predefined portion of a PES 100. Rewards and/or events may occur after a milestone.

Once participants are enrolled into the curriculum and/or program, the PES 100 is engaged. Staff of the program/curricula follow simple guidelines and completion charts for each participant in order to provide the appropriate “story drop”, “event”, “rewards”, or “core learning element” in a way that allows for either linear or non-linear story engagement from all participants with either simultaneous or rolling enrollment. Storytelling elements of the PES 100 are divided into core storyline elements with multiple potential outcomes and “hidden” or “Easter egg” elements that can be uncovered with proactive engagement and investigation. The different PES 100 elements act together as a single interlocking and overlapping behavioral modification and reinforcement system for the base core learning content. The PES 100 is a highly flexible system individually tailored to the desired constraints of the program/curricula. Furthermore, dynamic and real time “in the moment” rewards are built into the system through the accumulation of points into multiple categories. Points are accumulated via reactionary staff rewards for desired behavior/learning and can be awarded at either individual or multiple tiers, for example “individual”, “tribal”, and “group”. Once point limits are reached, an appropriate reward is released for the participant(s). The PES 100 can be broken down into a set of core learning/curricula that are marked by, interwoven with, and/or seemingly separate from events, story drops, and rewards (depending on program/curricula design and need). The option for “rites of passage” to mark especially significant events in the program/curricula may also be integrated into the program as focal points for divergent elements. These may be graduations, initiations, level achievements, etc., the participant would engage in the program and perceive the storytelling elements as linear even though they may not be. The beginning, ending, and desired mid points would be the only story elements required to be in order.

Participation by the participant in the treatment curricula and/or program creates positive engagement in a program/curricula. Participation by the participant in the treatment curricula and/or program encourages progression in a program/curricula. Participation by the participant in the treatment curricula and/or program creates a sense of curiosity and encourages self-motivation. Participation by the participant in the treatment curricula and/or program prevents hyper focus or dwelling on uninteresting/upsetting components of the program/curricula. Participation by the participant in the treatment curricula and/or program provides a self-reflective mirror through concurrent character progress and story events. And, participation by the participant in the treatment curricula and/or program provides common ground and point of interest for participants.

The various embodiments of the PES 100 may utilize transmedia storytelling combined with gamification, motivational engagement, and a “choose your own adventure” style reinforcement system in order to teach/learn a base or core curricula corresponding to the CL elements 206. Storytelling can be conducted via a combination of tangible (physical) drops, interpersonal drops, visual drops, and virtual reality drops. Creates an augmented virtual reality system that goes beyond an electronic medium for greater engagement and immersion. For example, but not limited to, a virtual reality (VR) transmedia gamification system may be used for a particular story line drop wherein the participant interacts in a VR environment (via I/O device 110 such as, but not limited to, a VR headset or the like) and with a physical prop or the like to experience that story line drop and to internalize the associated core learning element of that particular story line drop.

Tiered rewards system (individual, tribal, group) that effects the participant's engagement from multiple angles and with multiple, transmedia rewards (physical, interpersonal, visual, virtual, story) may be included as part of the PES 100. Learning engagement modality that creates a fully immersive experience for participants so that not only immediate, directive direction is given but also subtle background cultural direction and inter-peer direction may be provided by the PES 100.

When the PES 100 is managed by the computer system 102, the selection and timing of the delivery of particular story line drops can be managed for a particular participant. One skilled in the art appreciates that some participants digest and learn information at different rates. If a particular CL element 206 is not satisfactorily learned or experienced by the participant, reinforcement, supplemental, and/or alternative story line arc(s) 204 may be identified by the PES 100 so that a story line drop can be made available to the participant before progression through the main story line resumes.

Further, one or more participants can be grouped into tribe or the like. A tribe might be a small group of participants, such as roommates or the like. The larger group of participants may be comprised of a plurality of tribes. A tribal group may separately receive rewards and/or story line drops. All participants are members of the greater group of participants. The greater group may also separately receive rewards and/or story line drops.

When the PES 100 is managed by the computer system 102, the overall story line and/or individual story line arcs 204 can be managed in a coordinated fashion among the plurality of participating participants. Thus, differences in progression by individual participants can be managed with respect to other participants. Further, events may be held and/or rewards (generally indicated by reference numeral 214) may be granted on a tribal or group basis to foster teamwork building among participants. An example reward event may be a rite of passage event. Preferably, rewards are given and/or events are held proximate to presentation of an end of a story line arc 204 so that the participant will not be interrupted in the middle of the story line arc 204 that they are currently consuming.

As another non-limiting example, new participants may enter into the treatment curricula and/or program after other participants have started their treatment curricula and/or program. When the PES 100 is managed by the computer system 102, the newly participating participant may be integrated into the progression of the story line with other participants. For example, selected story line arcs 204 may be omitted, story line drops may be more quickly made, and/or the order of presentation of story line arcs 204 may be adjusted, so that the new participant catches up in the story with other participants. Alternatively, or additionally, supplemental story line arcs 204 may be made available to other selected participants to slow their progress through the story line, thereby providing time for the new participant to catch up on the story line.

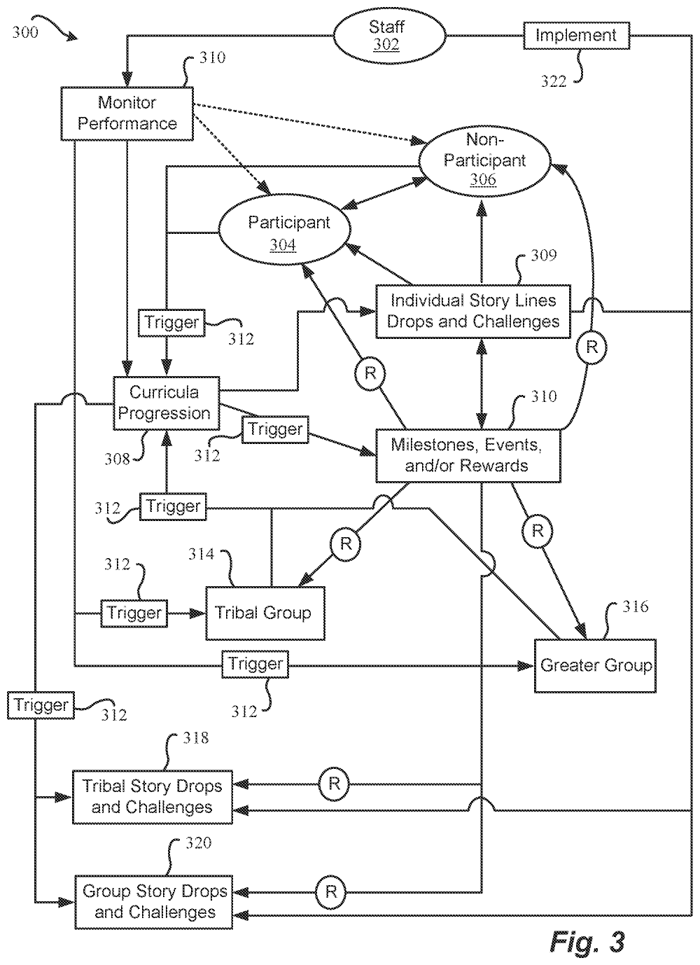

FIG. 3 is a flow chart 300 showing operations of an embodiment of the PES 100. The flow chart 300 conceptually illustrates the interaction between staff 302 (who are managing the PES 100), a participant 304 (a patient who is engaged in the PES 100), and a non-participant 306 (a patient who is not engaged in the PES 100) during the PES 100 curricula progression 308.

At certain points during curricula progression 308, story line drops (individual story line arcs 204 and the associated CL element 206) and/or challenges are dropped (at block 309). A participant 304 is an individual who is consuming their delivered story line arcs 204 and the associated CL element 206, and or who is performing a challenge. A challenge may be some type of task, puzzle, or questionnaire that the participant must complete. In some embodiments, the participant may be presented with a reward after the participant successfully completes the challenge.

Here, the participant 304 is experiencing and internalizing the core learning that is being presented by the PES 100. In contrast, the non-participant 306 may be resisting consumption of the story line arcs 204 and/or learning about and internalizing the associated CL element 206.

The staff 302, at block 310 monitors the curricula progression 308 as the plurality of story line arcs 204 are being presented to a plurality of participants 304 (and one or more non-participants 306 if present). Also, the staff 302 monitors the progression of each of the participants 304 and non-participants 306 as they consume the story line arcs 204 and the associated CL element 206. Such progress information is entered by the staff 302 into the PES 100.

The PES 100 may instruct the staff 302 to have one-to-one interactions with the participants 304 and/or non-participants 306 as needed. Alternatively, or additionally, the staff 302 during monitoring of the progress of the participants 304 and non-participants 306 may initiate a one-to-one interaction. For example, a participant 304 may have questions about the story line arcs 204 and the associated CL element 206 which may be addressed by the staff 302. The one-on-one interaction permits the staff 302 to interact with and answer questions of the participant 304. As another example, the staff 302 may work with a non-participant 306 to address, and possibly resolve, any issues that are interfering with the participation of the non-participant 306 in the PES 100.

From time to time, milestones, events, and/or rewards 310 may be issued by the PES 100. Issuance of milestones, events, and/or rewards (R) is based on predefined triggers 312. When the conditions of a predefined trigger 312 are met, the PES 100 issues the associated milestone, event, and/or reward. For example, when a participant 304 completes a particular task, challenge or the like in a currently presented story line arc 204 and the associated CL element 206, the trigger conditions being monitored as part of the PES 100 are satisfied. In response to satisfaction of the trigger requirements, the associated milestone, event, and/or reward 310 may be issued by the PES 100.

Additionally, or alternatively, the staff 302 may monitor progression of the plurality of tribal groups 314 and the greater group 316. Triggers 312 may be used to provide milestones, events, and/or rewards 310 to a tribal group 314 based on the tribal group's progression through the story line arcs 204 and the associated CL elements 206. Similarly, triggers 312 may be used to provide milestones, events, and/or rewards 310 to a greater group 316 based on the greater group's progression through the story line arcs 204 and the associated CL elements 206.

As presentation and consumption of the story line arcs 204 and the associated CL element 206, the progression through the curricula is tracked by the PES 100. The PES 100 can track progression of individual participants 304, non-participants 306, tribal groups and the greater group.

By tracking this progress at the curricula progression 308 block, the PES 100 may manage story line drops and/or challenges 309. Individual story line arc 204 and the associated CL element 206 can be accessed, and then delivered to the participants 304, the non-participants 306, the tribal group 314 (tribal story drop and challenges 318) and/or the greater group 316 (group story drops and challenges 320). The story line drops and/or challenges 309 may be electronic, and delivered to electronic devices being used by the participants 304, the non-participants 306, the tribal group 314 and/or the greater group 316. Alternatively, or additionally, the story line drops and/or challenges 309 may be delivered in a tangible physical form, such as a book, a package, a note, a scroll, a map, or the like.

Additionally, or alternatively, challenges, milestones, events, and/or rewards may be managed at the curricula progression 308 block. When a trigger condition is met, then the story drop, challenges, and/or any milestones, events, and/or rewards, may be initiated. For example, but not limited to, the rewards may be electronic, and delivered to electronic devices being used by the participants 304, the non-participants 306, the tribal group 314 and/or the greater group 316. Alternatively, or additionally, the rewards may be delivered in a tangible physical form, such as a book, a package, a note, a scroll, a food treat, a pass, apparel, badges, or the like

The story drop, challenges, milestones, events, and/or rewards, initiated by the curricula progression 308 may be delivered to the participants 304, the non-participants 306, the tribal group 314 and/or the greater group 316. Since the PES 100 is managing presentation of the story line arcs 204 and the associated CL element 206, particular story line arcs 204 and the associated CL element 206 can be dropped to the participants 304, the non-participants 306, the tribal group 314 and/or the greater group 316 on an individual basis. Accordingly, the participants 304, the non-participants 306, the tribal group 314 and/or the greater group 316 can each progress through the story line at their own pace with individual delivery of story line arcs 204 and the associated CL element 206 at a suitable time, preferably after completion of the prior story line arc 204 and the associated CL element 206. In some instances, such as, but not limited to, when a particular participant 304 or non-participant 306 has fallen significantly behind in keeping up with the others, the PES 100 may selectively advance such participants so that their series of delivered story line arcs 204 and the associated CL element 206 keep pace with the other participants. For example, one or more story line arcs 204 and the associated CL element 206 drops may be omitted, thereby advancing that participant's position in the story line so as to become consistent with the position of other participants. Optionally, if a particular story line drop has been omitted for a particular participant, the PES 100 can identify a suitable time wherein that missed storyline drop can be given to that participant so that the participant experiences the entire story line, thereby facilitating group and/or tribal consistence and individual participant experience of the entire, or the most significant portions of, the PES 100.

In some situations, the staff 302 implements (at block 322) story line drops and/or challenges 309, milestones, events, and/or rewards 310. Here, the staff 302 may deliver a tangible form story line arcs 204 and the associated CL element 206 to the participants 304, the non-participants 306, the tribal group 314 and/or the greater group 316.

FIG. 3 also conceptually illustrates that a particular participant 304 can transition to a non-participant 306, and that a non-participant 306 can transition to a participant 304. For example, partway through the story line 202, a participant 304 may have feelings that they no longer wish to be engaged in the PES 100 presentation of the story line 202 and/or the treatment curricula and/or program of the PES 100. They may become dissociative, reluctant to participate, or even become aggressive towards others such as the staff 302. That is, the participant 304 transforms into a non-participant 306. Here, when this occurs, the PES 100 may modify the story line 202 in a manner that may be more agreeable to the non-participant 306. With optional assistance from the staff 302, the PES 200 may be able to more engage the non-participant 306, and then transform the non-participant 306 back to a participant 304 to secure participation in the PES 100 treatment curricula and/or program. Non-participants 306 may be similarly converted at any time during the PES 100 presentation of the treatment curricula and/or program.

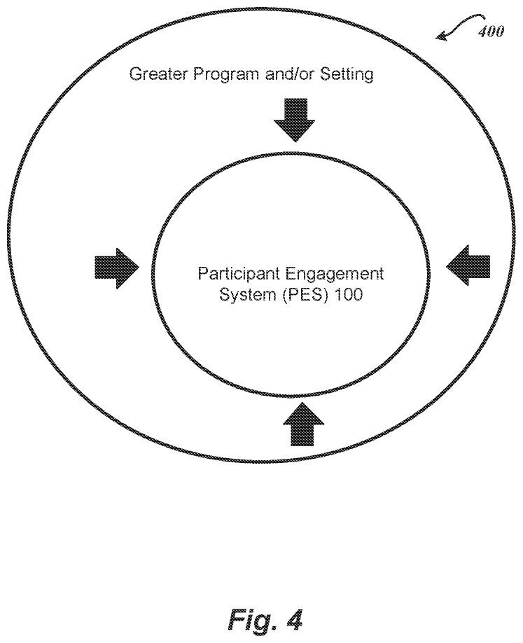

FIG. 4 is a PES program and/or setting interaction chart 400. A particular program and/or setting may involve many different participants 304, the non-participants 306, the tribal group 314 and/or the greater group 316. One skilled in the art appreciate that the participants 304 and/or non-participants 306 will have different needs and/or challenges to overcome while at the program or at the program setting. Any particular PES may be configured to treat selected participants 304, selected non-participants 306, selected tribal group 314 and/or the greater group 316, wherein the treatment curricula and/or program of a particular PES 100 can be directed towards. Further, a plurality of different PESs 100 can concurrently operate. And, particular participants 304, non-participants 306, tribal groups 314 and/or the greater group 316 can concurrently participate in multiple different PESs 100.

It should be emphasized that the above-described embodiments of the PES 100 are merely possible examples of implementations of the invention. Many variations and modifications may be made to the above-described embodiments. All such modifications and variations are intended to be included herein within the scope of this disclosure and protected by the following claims.

Furthermore, the disclosure above encompasses multiple distinct inventions with independent utility. While each of these inventions has been disclosed in a particular form, the specific embodiments disclosed and illustrated above are not to be considered in a limiting sense as numerous variations are possible. The subject matter of the inventions includes all novel and non-obvious combinations and subcombinations of the various elements, features, functions and/or properties disclosed above and inherent to those skilled in the art pertaining to such inventions. Where the disclosure or subsequently filed claims recite “a” element, “a first” element, or any such equivalent term, the disclosure or claims should be understood to incorporate one or more such elements, neither requiring nor excluding two or more such elements.

Applicant(s) reserves the right to submit claims directed to combinations and subcombinations of the disclosed inventions that are believed to be novel and non-obvious. Inventions embodied in other combinations and subcombinations of features, functions, elements and/or properties may be claimed through amendment of those claims or presentation of new claims in the present application or in a related application. Such amended or new claims, whether they are directed to the same invention or a different invention and whether they are different, broader, narrower or equal in scope to the original claims, are to be considered within the subject matter of the inventions described herein.

Therefore, having thus described the invention, at least the following is claimed:

1. A treatment curricula presentation method, comprising:
identifying a first story line arc that is to be presented to a participant in a participant engagement system (PES), wherein the first story line arc is identified using a story line management engine executing on at least one of a processor or a central processing unit (CPU);
presenting the first story line arc to a participant,
wherein the first story line arc is one of a serially presented plurality of story line arcs,
wherein the plurality of story arcs define a story line,
wherein each storyline has an associated theme pertaining to a treatment curricula, and
wherein the first story line arc has an associated first core learning element that is internalized by the participant during the course of consuming the first story line arc;
monitoring the participant during and after presentation of the first story line arc using the story line management engine executing on the processor or the CPU, wherein the monitoring determines whether the participant has consumed the first story line arc based on input received from staff made via an input/output (I/O) device; and
presenting a second story line arc to the participant,
wherein the second story line arc has an associated second core learning element that is internalized by the participant during the course of consuming the second story line arc,
wherein the second core learning element is different from the first core learning element, and
wherein the second story line arc is presented to the participant after presentation of the first story line arc.

2. The method of claim 1, wherein the second story line arc is presented to the participant only if the monitoring indicates that the participant has internalized the first core learning element of the first story line arc.

3. The method of claim 1, wherein the theme of the storyline presents a story that induces a positive change in at least one of a behavior, a belief, and character of the participant.

4. The method of claim 1, further comprising:
presenting the participant with a reward after a conclusion of the presentation of the first story line arc.

5. The method of claim 1, further comprising:
presenting a challenge to the participant after a conclusion of the presentation of the first story line arc; and
presenting the participant with a reward to the participant after the participant successfully completes the challenge.

6. The method of claim 1, further comprising:
monitoring the participant's progression through a portion of the story line that encompasses a plurality of serial story line arcs; and
presenting the participant with a reward after a conclusion of the presentation of the portion of the story line that encompasses a plurality of serial story line arcs.

7. The method of claim 1, further comprising:
monitoring the participant's progression through a portion of the story line that encompasses a plurality of serial story line arcs;
presenting a challenge to the participant after a conclusion of the presentation of the portion of the story line that encompasses a plurality of serial story line arcs; and
presenting the participant with a reward to the participant after the participant successfully completes the challenge.

8. The method of claim 1, further comprising:
instructing staff to conduct a one-to-one interaction with the participant based on the monitoring of the participant.

9. The method of claim 1, wherein monitoring the patient further comprises:
monitoring the participant during and after presentation of the first story line arc to determine whether the participant has internalized the first core learning element associated with the first story line arc.

10. The method of claim 1, further comprising:
accessing the first story line arc from a storyline library in a memory, wherein the first story line arc is presented to the participant in response to accessing the first story line arc from the storyline library; and
accessing the second story line arc from a storyline library in a memory, wherein the second story line arc is presented to the participant in response to accessing the second story line arc from the storyline library.

11. The method of claim 1, wherein presenting the first story line arc to the participant further comprises:
presenting a virtual reality (VR) transmedia gamification system to the participant,
wherein the participant interacts in a VR environment and at least one physical prop to experience the first story line arc and to internalize the associated core learning element of the first story line arc.

12. A treatment curricula presentation system, comprising:
a storyline library residing in a memory of a computer system,
wherein a story line resides in the storyline library,
wherein each storyline has an associated theme pertaining to a treatment curricula, and
wherein the story line comprises a serially arranged plurality of story line arcs that define the story line, and
wherein each story line arc has an associated core learning element that is internalized by the participant during the course of consuming the corresponding story line arc;
a processing system communicatively coupled to the memory;
a story line management engine residing in the memory, wherein the story line management engine when executed by the processing system is configured to;
present a first story line arc to a participant, wherein the first story line arc is one of the plurality of story line arcs, and wherein the first story line arc has an associated first core learning element that is internalized by the participant during the course of consuming the first story line arc;
monitor the participant during and after presentation of the first story line arc to determine whether the participant has consumed the first story line arc; and
present a second story line arc to the participant, wherein the second story line arc is one of the plurality of story line arcs, wherein the second story line arc has an associated second core learning element that is internalized by the participant during the course of consuming the second story line arc, wherein the second core learning element is different from the first core learning element, and wherein the second story line arc is presented to the participant after presentation of the first story line arc.

13. The system of claim 12, wherein the second story line arc is presented to the participant only if the monitoring by the story line management engine indicates that the participant has internalized the first core learning element of the first story line arc.

14. The system of claim 12, wherein the theme of the storyline presents a story that induces a positive change in at least one of a behavior, a belief, and character of the participant.

15. The system of claim 12, wherein the story line management engine is further configured to:
present the participant with a reward after a conclusion of the presentation of the first story line arc.

16. The system of claim 12, wherein the story line management engine is further configured to:
present a challenge to the participant after a conclusion of the presentation of the first story line arc; and
present the participant with a reward to the participant after the participant successfully completes the challenge.

17. The system of claim 12, wherein the story line management engine is further configured to:
monitor the participant's progression through a portion of the story line that encompasses a plurality of serial story line arcs; and
present the participant with a reward after a conclusion of the presentation of the portion of the story line that encompasses a plurality of serial story line arcs.

18. The system of claim 12, wherein the story line management engine is further configured to:
monitor the participant's progression through a portion of the story line that encompasses a plurality of serial story line arcs;
present a challenge to the participant after a conclusion of the presentation of the portion of the story line that encompasses a plurality of serial story line arcs; and
present the participant with a reward to the participant after the participant successfully completes the challenge.

19. The system of claim 12, wherein the story line management engine is further configured to:
instruct staff to conduct a one-to-one interaction with the participant based on the monitoring of the participant.

20. The system of claim 12, wherein the story line management engine is further configured to:
monitor the participant during and after presentation of the first story line arc to determine whether the participant has internalized the first core learning element associated with the first story line arc.
